(19) United States
(12) Patent Application Publication
(10) Pub. No.: US 2023/0406781 A1
(43) Pub. Date: Dec. 21, 2023

(54) GYPSUM SLURRY MIXER PROCESS FOR ENHANCED WALLBOARD STRENGTH

(71) Applicant: UNITED STATES GYPSUM COMPANY, Chicago, IL (US)

(72) Inventors: Annamaria VILINSKA, Chicago, IL (US); Mark HEMPHILL, Hawthorn Woods, IL (US); Naser ALDABAIBEH, Homer Glen, IL (US); Mark ANTOSH, Wheeling, IL (US)

(21) Appl. No.: 18/295,516

(22) Filed: Apr. 4, 2023

Related U.S. Application Data
(60) Provisional application No. 63/366,480, filed on Jun. 16, 2022.

(51) Int. Cl. C04B 40/00; C04B 11/00

(52) U.S. Cl. CPC C04B 40/0028; C04B 11/00; C04B 2111/0062

(57) ABSTRACT

A process is provided for creating a gypsum wallboard slurry with enhanced strength. The process includes providing a gypsum wallboard slurry mixer, providing suitable amounts of calcined gypsum and water in the mixer to create a slurry, agitating the slurry in the mixer, extracting a portion of the slurry in the mixer, reintroducing the extracted portion into the mixer for further mixing, and dispensing the mixed slurry from an outlet of the mixer.

### RELATED APPLICATION

The present application is a Non-Provisional of, and claims 35 U.S.C. 119 priority from, U.S. patent application Ser. No. 63/366,480 filed Jun. 16, 2022, the contents of which are incorporated by reference herein.

### BACKGROUND

The present invention relates generally to the production of gypsum wallboard panels, and more specifically to operation of a gypsum slurry mixer used to produce the slurry forming the core of the wallboard panels.

It is well known to produce gypsum products (i.e., products comprising calcium sulfate dihydrate) from starting materials comprising calcined gypsum (i.e., calcium sulfate hemihydrate) and water. A popular application of gypsum chemistry is in the production of gypsum wallboard panels. The basic technology of gypsum wallboard panel manufacture is disclosed in U.S. Pat. Nos. 1,500,452; 2,207,339 and 4,009,062 all of which are incorporated by reference. In this process, calcined gypsum is uniformly dispersed in water to form a slurry, and then the slurry is deposited upon a continuously moving web of facing paper located on a conveyor line. After deposit upon the face paper, a top layer of backing paper is deposited upon the slurry, which is then cast into a desired shape and allowed to set to form hardened gypsum by reaction of the calcined gypsum (calcium sulfate hemihydrite or anhydrite) with the water to form hydrated gypsum (calcium sulfate dihydrate). As is well known in the art, after the panels are formed, they are heated to dry the excess water, and cut into building panels.

In the formation of the gypsum slurry, a mixer is typically used to mix the dry calcined gypsum, water and selected additives. Gypsum wallboard slurry mixers are well known in the art, and suitable examples are described in U.S. Pat. Nos. 6,494,609; 6,059,444; and 3,459,620, all of which are incorporated by reference. A gypsum wallboard slurry mixer typically includes a housing defining a mixing chamber with inlets for receiving separate supplies of calcined gypsum and water, among the additives which are well known in the art. The mixer includes a rotating pin-laden disk, impeller or other type of agitator for agitating the contents to be mixed into a mixture or slurry. The discharge gate controls the flow of slurry from the mixer to the dispensing system.

Designers of gypsum wallboard production lines usually have performance goals for the board as it is being formed, as well as of the resulting wallboard panels. These goals include, among other things, rapid setting time and reduced water demand to reduce kiln time and accompanying drying energy, reduced panel weight to facilitate installation, and panel strength for desired structural integrity of the resulting wall, often measured as Nail Pull. Nail Pull is the force in pounds needed to pull a panel over the head of a nail securing the panel to a framing stud of wood or metal. Techniques used by wallboard production designers to improve Nail Pull and control of hydration or water demand include the use of HRA and centrifugal comminution machines, one example of the latter is sold by Entoleter LLC of Hamden, Connecticut, USA under the trademark Entoleter®.

HRA stands for Heat Resistant Accelerator, and is a combination of low moisture landplaster and dextrose (sugar). In the course of wallboard manufacturing, HRA is typically mixed with other dry gypsum wallboard ingredients or additives prior to adding water to form the gypsum wallboard slurry. HRA has been found to enhance the development of crystals in the gypsum as the hydration process (hemihydrate to dihydrate) progresses, which causes the gypsum to set and harden, forming the wallboard core. Thus, HRA is known to enhance wallboard strength, to increase setting at the point where the set panels are cut to a desired panel length along the production line, and to complete hydration before the board is sent to a kiln for drying. Typically, HRA makes up about only 1% of the feed stock of dry wallboard ingredients, but enhances the performance of the resulting gypsum wallboard, in that less gypsum hemihydrate is needed to create the panels due to the enhanced crystal formation properties of HRA. In conventional wallboard processing, the HRA is produced in a ball mill rotating at approximately 70 RPM before being placed in a feed hopper.

Entoleter® comminuters or mills reduce the stucco particle size and increase the fraction of slurry particles in the 1-10 microns size range. A representative description of an Entoleter® comminuter is found in U.S. Pat. No. 4,083,504 which is incorporated by reference. A production goal using these comminuters is producing at least 20-30% of the gypsum particles (by volume) to be in the range of 1 to 10 microns. For comparison, conventional synthetic gypsum sources have a rather narrow size distribution of 40-50 microns and almost negligible number of particles smaller than that. In this way, the specific surface area (cm²/gram) of calcined gypsum is increased. Using such source material without comminution reduces ultimate board strength. Entoleter® comminuters are used to increase gypsum strength via Nail Pull (increases of 2-5 lbs) and have a slight impact on setting and hydration. However, the use of both HRA and Entoleter® comminuters carries significant and operational expenses.

In an effort to achieve the process benefits of the above-listed measures while reducing production costs, one technique has been to employ a “micro crystallizer” in lieu of HRA. A micro crystallizer is a dedicated mixer and mill for stucco and water agitation. However, the short residence time of stucco in the system did not allow for any dihydrate formation, and was essentially just a highly agitated mixed hemihydrate slurry pumped into the main mixer. This technology basically required the operation and maintenance of two mixers and was phased out and replaced by other dihydrate-based systems and HRA.

Thus, there is a need for providing a source for smaller gypsum particles in the wallboard production process that achieves the benefits of HRA and Entoleter® comminuters, without the attendant expense of these technologies.

### SUMMARY

The above-listed need is met or exceeded by the present gypsum slurry production process, in which a portion of the mixer slurry is extracted from the mixer and returned to the mixer for a “second mixing.” It has been found that this technique reduces the stucco particle size of the returned slurry portion, and creates a sub fraction of smaller particles proportional to the amount of returned slurry. Stucco particle size naturally decreases as it passes through the mixer due to dissolution and the very high shear forces present in a typical gypsum wallboard pin mixer. Thus, by subjecting a selected portion of the conventional gypsum slurry to supplemental agitation in the mixer, the particle size is sufficiently reduced to simulate the use of HRA or an Entoleter® comminuter without incurring the respective costs.

To implement the present process, a modification of the existing mixer includes the use of an existing extractor conventionally used to divert a portion of the slurry for creating a relatively higher density layer adjacent the face paper, and a hose or conduit connected to the extractor and directed back into the mixer to redirect the diverted slurry portion back into a main mixing chamber for additional mixing. Optionally, water or other additives are contemplated as being added to the diverted slurry portion. However, the main objective of the present process is to “double mix” a selected portion of the slurry and increase the percentage of fine particles in the total of particles forming the slurry.

In an embodiment, up to 20% of the volume of slurry in the mixer is diverted for remixing. In another embodiment, approximately 5-7% of the volume of the slurry in the mixer is diverted for remixing. Preferably, the diverted flow of slurry is reintroduced into the existing mixer vent. The approximate residence time in the mixer for the recycled, reintroduced slurry is in the range of 2-3 seconds.

More specifically, a process is provided for creating a gypsum wallboard slurry with enhanced strength. The process includes providing a gypsum wallboard slurry mixer, providing suitable amounts of calcined gypsum and water in the mixer to create a slurry, agitating the slurry in the mixer, extracting a portion of the slurry in the mixer, reintroducing the extracted portion into the mixer for further mixing, and dispensing the mixed slurry from an outlet of the mixer.

In an embodiment, the mixer further includes at least one extractor, and the extracted portion of the slurry is dispensed in a conduit connected to the extractor into a port for reintroduction into the mixer. In an embodiment, up to 20% of a volume of the slurry in the mixer is diverted and reintroduced for further mixing. In another embodiment, approximately 5-7% of the slurry volume is reintroduced into the mixer for supplemental mixing. In yet another embodiment, the reintroduced slurry resides in the mixer for 2-3 seconds. It is also contemplated that the mixer is provided with upper and lower extractors, and the extracted portion of the slurry is dispensed in a conduit connected to the upper extractor and reintroduced into a port in the mixer.

In another embodiment, a process is provided for creating a gypsum wallboard slurry with enhanced strength, including providing a gypsum wallboard slurry mixer, providing suitable amounts of calcined gypsum and water in the mixer to create a slurry, agitating the slurry in the mixer, extracting up to 20% of the volume of slurry in the mixer, reintroducing the extracted portion into the mixer for further mixing for 2-3 seconds, and dispensing the mixed slurry from an outlet of the mixer.

### BRIEF DESCRIPTION OF THE DRAWINGS

FIG. 1 is a top plan view of a gypsum mixer configured for performing the present process;

FIG. 2 is a vertical cross-section of the mixer of FIG. 1 taken along the line 2-2 of FIG In in the direction generally indicated; and

FIG. 3 is a top perspective view of the mixer agitator used in the mixer of FIG. 1.

### DETAILED DESCRIPTION

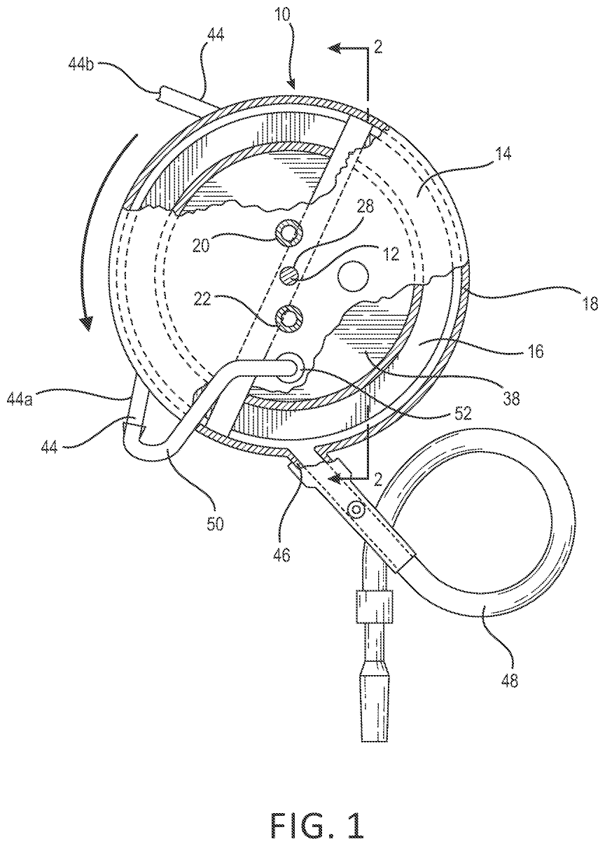

Referring now to FIGS. 1-3, a gypsum wallboard slurry mixer is generally designated 10, having a generally cylindrical shape, with a generally vertical axis 12, an upper wall 14, a lower wall 16 in generally parallel vertically displaced orientation to the upper wall and an annular peripheral wall 18 secured to and vertically spacing the upper and lower walls. An inlet 20 for calcined gypsum and an inlet 22 for water are both preferably positioned in the upper wall 14, preferably proximate the vertical axis 12. It is contemplated that the location of the inlets 20, 22 may vary to suit the application, and may be provided in the lower wall 16 depending on the application. Also, the inlets 20, 22 are connected to corresponding supplies of calcined gypsum and water that deliver constituents to the mixer 10 by gravity feed. Also, as is well known in the art, other materials in addition to gypsum and water are added to the slurry to prepare gypsum products, such materials, collectively referred to as additives, including but are not limited to accelerators, foam, retarders, fillers, binders and the like. The additives are supplied through the inlets 20, 22 or through supplemental designated inlets.

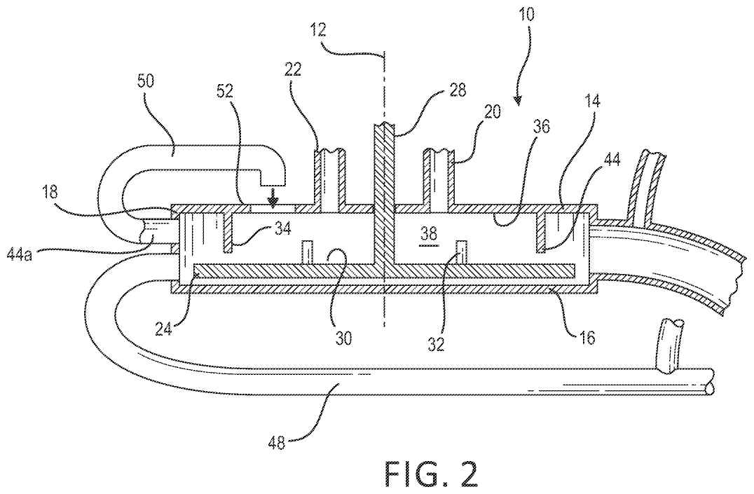

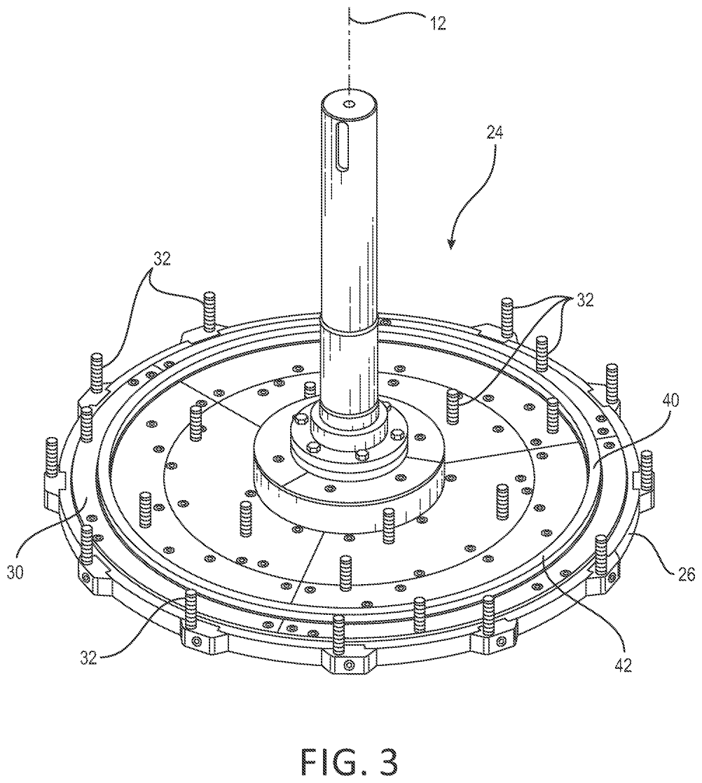

Referring now to FIGS. 2 and 3, an agitator 24 includes a circular disc 26 connected to a drive shaft 28 that is preferably located at the vertical axis 12. Preferably, the drive shaft 28 projects along the vertical axis from the upper wall 14. A motor (not shown) is connected to the drive shaft 28 and axially rotates the shaft and the disc 26. In the present embodiment, the shaft 28 and the disc 26 rotate counter-clockwise, however it is contemplated that rotation is optionally clockwise depending on the application and the mixer. An upper surface 30 of the disc 26 preferably is provided with at least one vertically projecting agitating formation 32 such as a pin or a paddle to enhance agitation of the slurry. In addition, the mixer 10 preferably includes an annular ring 34 connected to and depending from an inner surface 36 of the upper wall 14. The ring 34 is often referred to as a “lid ring”, and enhances mixing action in the mixer 10 by preventing larger agglomerations or lumps of calcined gypsum from exiting an interior chamber 38 of the mixer before becoming more finely divided and dispersed in the slurry. As is known in the art, the agitator 24 is located within the chamber 38. Under normal operation, a supply of calcined gypsum is provided into the inlet 20, and a supply of water is provided into the inlet 22. The water and gypsum are mixed together in the mixing chamber 38 to form a slurry due to the rotation of the agitator 24.

Referring again to FIG. 3, it is also known to provide gypsum slurry mixers 10 with a so-called annular “lump ring” 40 attached to the upper surface 30 of the agitator disc 26. Preferably, the lump ring 40 has a diameter that is just smaller than the lid ring 34 and projects vertically upward, or opposite from the lid ring so that an upper edge 42 of the lump ring overlaps (while slightly radially displaced) a lower edge 44 of the lid ring to create a serpentine or labyrinth path for the slurry as it migrates from the vertical axis radially outwardly due to centrifugal force. A preferred height of the lump ring 40 is ⅜ inch (0.9525 cm).

Referring now to FIGS. 1 and 2, the mixer 10, is also equipped with at least one and preferably two extractors 44, in this case an upper extractor 44a and a lower extractor 44b are provided. Extractors 44 are pipes or other conduits used to divert a portion of the slurry from the mixer 10 so that the slurry has a first concentration or density. Then, the remainder of the slurry in the mixing chamber 38 is formulated to have a relatively lower density, as by adding water, foam and/or other additives. During production of the wallboard panels, the slurry diverted using the extractors 44 is deposited initially upon face paper for providing greater strength near the face paper for a more durable wallboard. Next, the slurry forming the core is deposited upon the higher density slurry.

Also included in the mixer 10 is a main gate 46 through which a majority of the slurry exits the mixer. Preferably, a discharge conduit or hose 48 is connected to the gate 46 to more accurately dispense the slurry upon a moving wallboard production line, as is well known in the art.

An important feature of the present process is that a supplemental conduit, such as a hose 50 is connected to one of the extractors 44, preferably the upper extractor 44a, and diverts a portion of the gypsum slurry from the mixing chamber 38 back into the chamber for additional or supplemental mixing. In the present embodiment, the supplemental conduit 50 is shown dispensing gypsum slurry through a port 52 designated as a breather vent. However, it is contemplated that the conduit 50 is optionally oriented to dispense the slurry into the gypsum inlet 20. Regardless of the location of the particular inlet port, the supplemental conduit 50 dispenses a selected portion of gypsum slurry back into the mixing chamber 38 for additional or further mixing, which reduces the average particle size of the remixed portion.

In the preferred embodiment, the conduit transports up to 20% of the volume of slurry in the mixer 10 into the port for additional or supplemental mixing. In one embodiment, approximately 5-7% of the volume of the slurry is diverted and reintroduced into the mixing chamber 38. Also, it is preferred that the reintroduced slurry has a residence time in the mixer 10 of approximately 2-3 seconds before it is dispensed with the remainder of the slurry out the discharge conduit 48 and onto a moving wallboard conveyor line for the production of wallboard panels as is well known in the art.

More specifically, the discharge conduit 48 deposits the slurry on to a moving conveyor line upon which a sheet of face paper has already been deposited. In some cases, a relatively higher density layer of wallboard slurry has previously been deposited upon the face paper prior to the deposition of the main slurry, which forms the core of the wallboard panel. A layer of backing paper is then deposited upon the slurry, and the conveyor line is configured for shaping the setting slurry and paper layers into a panel as the slurry sets. Once the slurry sets, the panels are cut apart, and then sent to a kiln for drying, where excess water is evaporated out of the panels.

Referring now to Table 1 below, in two separate wallboard production plants, the present process including diverting a portion of the slurry and reintroducing that portion into the mixer for additional mixing was compared with standard wallboard production techniques that did not involve the use of HRA or an Entoleter® comminuter. In Table 1, the Board Compressive Strength (BCS) values of the resulting panels were compared, with the control being the standard slurry, and the test slurry including the reintroduction of the portion of the slurry for supplemental mixing as described above. BCS is measured using a 4-inch diameter, 0.5-inch thick disc made with stucco, HRA and water. In the preferred test, the discs were made by mixing 300 g stucco, 3 g HRA, 3 g Sodium trimetaphosphate and 516 g water.

The discs are dried to constant weight and then crushed using a Universal Testing Machine. The procedure is very similar to the one described in ASTM C473, section X3 relating to Compressive Strength, with some small differences when it comes to conditioning and sample size/form. Any material will eventually fail when subjected to load, and the Compressive Strength is basically the failure load divided by the area of the sample. The higher the psi value, the stronger the material. Thus, BCS, like Nail Pull, is a measure of the strength of a wallboard panel.

Referring to Table 1, in one test, the Board Compressive Strength increased using the present process by 14% compared to the control, and in the other, the BCS increased 9%. Accordingly, the reintroduction of the portion of the slurry increased BCS strength on the order of the results obtained by adding HRA or using an Entoleter® comminuter.

TABLE 1
Comparison of gypsum core strength
of single and double mixed slurry

| | | BCS | Improvement with |
|---|---|---|---|
| | | (psi) | extra mixing |
| Bridgeport | 10 | 570 | |
| | Seconds Mixing | | |
| | 2 × 10 | 648 | 14% |
| | seconds Mixing | | |
| Sperry | 10 | 338 | |
| | Seconds Mixing | | |
| | 2 × 10 | 368 | 9% |
| | seconds Mixing | | |

Referring now to Table 2 below, the present process including diverting a portion of the slurry and reintroducing that portion into the mixer for additional mixing was compared with standard wallboard production techniques that did not involve the use of HRA or an Entoleter® comminuter. In particular, approximately 12% of the gypsum wallboard slurry was diverted and recirculated to the mixer. In Table 2, the BCS and Nail Pull values of the resulting panels were compared, with the control being the standard slurry. The test slurry included the reintroduction of the portion of the slurry for supplemental mixing as described in relation to Table 1 above, and the same test procedures were used to measure the BCS and Nail Pull.

TABLE 2
Comparison of gypsum core strength of gypsum board with
around 12% Entoleter ® comminuter

| | Dry wt | NP | BCS |
|---|---|---|---|
| | (lb/MSF) | (lbf) | (psi) |
| Control | 1377.6 | 80.2 | 462.0 |
| Condition 1 - with | 1360.2 | 81.0 | 487.5 |
| Entoleted Slurry | | | |
| Control | 1355.6 | 77.3 | 448.6 |

Referring to Table 2, the Nail Pull using approximately 12% recirculated slurry increased the Nail Pull by 1% and 5% compared to the two controls and the Board Compressive Strength increased by 6% and 9% compared to the two controls. Accordingly, the use of approximately 12% recirculated slurry increased Nail Pull and BCS strength.

While a particular embodiment of the present gypsum slurry mixer process for enhanced wallboard strength has been described herein, it will be appreciated by those skilled in the art that changes and modifications may be made thereto without departing from the invention in its broader aspects and as set forth in the following claims.

1. A process for providing a gypsum wallboard slurry with enhanced strength comprising:
providing a gypsum wallboard slurry mixer;
providing suitable amounts of calcined gypsum and water in the mixer to create a slurry;
agitating the slurry in the mixer;
extracting a portion of the slurry from the mixer;
reintroducing the extracted portion into the mixer for further mixing; and
dispensing the mixed slurry from an outlet of the mixer.

2. The process of claim 1, wherein said mixer further includes at least one extractor, and said extracted portion of the slurry is dispensed in a conduit connected to the extractor into a port in the mixer.

3. The process of claim 1 wherein up to 20% of a volume of the slurry in the mixer is diverted and reintroduced for further mixing.

4. The process of claim 1, wherein approximately 5-7% of the slurry volume reintroduced into the mixer for supplemental mixing.

5. The process of claim 1, wherein the reintroduced slurry resides in the mixer for 2-3 seconds.

6. The process of claim 1, wherein the mixer is provided with upper and lower extractors, and the extracted portion of the slurry is dispensed in a conduit connected to the upper extractor and reintroduced into a port in the mixer.

7. A gypsum wallboard panel manufactured using the process of claim 1.

8. A process for providing a gypsum wallboard slurry with enhanced strength, comprising:
providing a gypsum wallboard slurry mixer;
providing suitable amounts of calcined gypsum and water in the mixer to create a slurry;
agitating the slurry in the mixer;
extracting up to 20% of the volume of slurry from the mixer;
reintroducing the extracted portion into the mixer for further mixing for 2-3 seconds; and
dispensing the mixed slurry from an outlet of the mixer.

9. The process of claim 8, wherein approximately 5-7% of the slurry volume reintroduced into the mixer for supplemental mixing.

10. The process of claim 8, wherein approximately 12% of the slurry volume is reintroduced into the mixer.
